(19) United States
(12) Patent Application Publication
(10) Pub. No.: US 2008/0169917 A1
(43) Pub. Date: Jul. 17, 2008

(54) Identification System

(76) Inventor: Heinz-Josef Hautvast, Brigachtal (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/908,574

(22) PCT Filed: Jan. 10, 2006
(86) PCT No.: PCT/EP2006/050122

§ 371 Date: Sep. 13, 2007

(30) Foreign Application Priority Data
Mar. 15, 2005 (DE) 10 2005 012 215.9

(51) Int. Cl. G08B 5/00

(52) U.S. Cl. 340/468; 340/815.4

(57) ABSTRACT

An identification system for an object, particularly for an electrical or electronic device (1) is provided with an item of identification information. The object contains an electronic memory inside of which the item of identification information is stored. This memory is connected to a display device via which the item of identification information can be displayed.

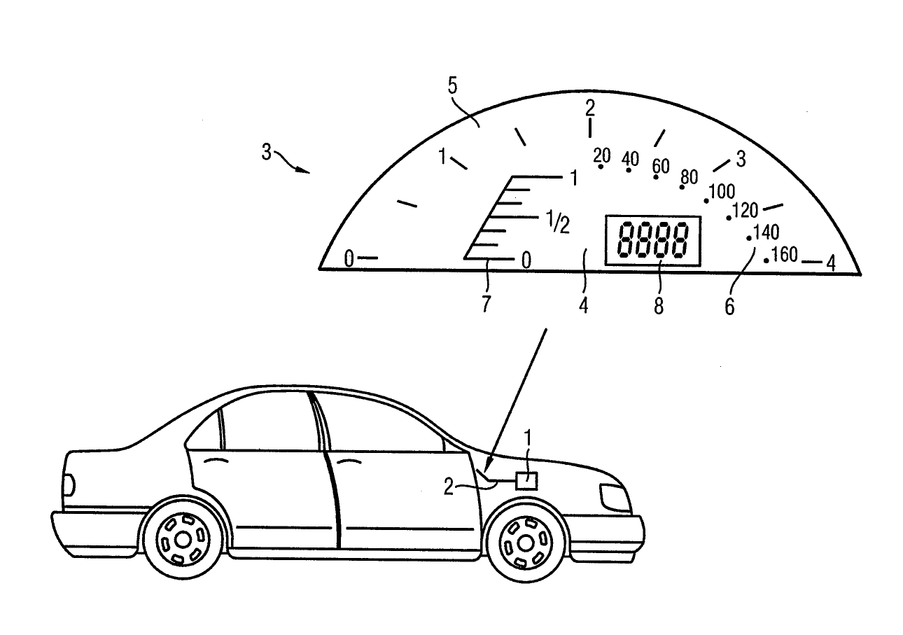

### CROSS-REFERENCE TO RELATED APPLICATIONS

This application is a U.S. national stage application of International Application No. PCT/EP2006/050122 filed Jan. 10, 2006, which designates the United States of America, and claims priority to German application number 10 2005 012 215.9 filed Mar. 15, 2005, the contents of which are hereby incorporated by reference in their entirety.

### TECHNICAL FIELD

The invention relates to an identification system for an object, in particular for an electrical or electronic device, which is provided with an item of identification information.

### BACKGROUND

In particular electronic devices which have to be approved by authorities require a type plate which contains specific identification data. These devices, which may be installed, for example, in a motor vehicle, are becoming increasingly small and compact and are highly integrated with respect to their function. Furthermore, the surfaces of the device which can be easily seen after installation are usually covered by interfaces, pushbutton keys, displays and output devices such as, for example, printers, so that there is no sufficient space available for mounting a type plate which permits the identification data to be presented with a size which can still be read.

### SUMMARY

An identification system of the type mentioned above can be provided which, even when the object is of a small overall size, permits the identification data to be presented with a size which can easily be read.

According to an embodiment, an identification system for an electrical or electronic device, can be provided with an item of identification information, wherein the device is of a size which is insufficient for the identification to be mounted with a readable size, and the electrical or electronic device contains an electronic memory in which the item of identification information is stored, wherein the memory is connected or can be connected to a display device which is arranged at a different location than the electrical or electronic device by means of which the item of identification information can be displayed.

According to an enhancement, the memory can be a read-only memory (ROM). According to a further enhancement, the item of identification information can be stored encoded in the memory, and the display device may contain a decoding stage for decoding the item of identification information. According to a further enhancement, the item of identification information can be stored cryptographically encoded in the memory. According to a further enhancement, the display device may have an electro-optical display panel for displaying of the item of identification information. According to a further enhancement, the item of identification information can be displayed by the display device on demand. According to a further enhancement, the object and/or the display device may have an interface for coupling with a further display unit. According to a further enhancement, the further display unit can be a personal computer (PC). According to a further enhancement, the electrical or electronic device can be an electrical or electronic device of a motor vehicle, and the display device can be a display instrument which is arranged in the dashboard of the motor vehicle. According to a further enhancement, information can be displayed by the display instrument under the control of a user menu, and the information display can be an item on the user menu.

### BRIEF DESCRIPTION OF THE DRAWINGS

An exemplary embodiment of the invention is illustrated in the drawing. The single FIGURE of the drawing shows a side view of a motor vehicle with a display instrument shown in a separate enlarged view.

### DETAILED DESCRIPTION

According to an embodiment, the object contains an electronic memory in which the item of identification information is stored, wherein the memory is connected or can be connected to a display device by means of which the item of identification information can be displayed.

According to another embodiment, if the object already has a display device for other purposes, said display device can also be used to display the identification data so that there is no need for a special place on the object for said data.

However, it is also possible, according to an embodiment, for the display device to be arranged at a completely different location than the object.

According to an embodiment, the size with which the identification data are displayed by the display device is independent of the space available on the object.

In order to avoid tampering with the identification data, the memory can be a read-only memory (ROM).

For this purpose, the item of identification information can also be stored encoded, in particular cryptographically encoded, in the memory, and the display device can contain a decoding stage for decoding the item of identification information.

The display device preferably has an electro-optical display panel on which the item of identification information can be displayed.

If the item of identification information does not have to be continuously made available, it can be displayable by the display device on demand.

The object and/or the display device can have an interface to which a display unit can be connected.

This permits the display device to be a display unit which can be connected only when required. However, a display unit which can be additionally connected to the display device may also be possible. As a result, supervisory bodies, for example the police, can connect their own display device and check the identity of the object. In this context, the further display unit is preferably a personal computer (PC).

It can be particularly advantageous if the object is a component, in particular an electrical or electronic device of a motor vehicle, and the display device is a display instrument which is arranged in particular in the dashboard of the motor vehicle.

As a result, the objects which are to be identified can also be installed at locations in the motor vehicle which are difficult to access, and nevertheless their identity can be checked.

Since the information to be displayed in display instruments nowadays can usually be displayed under the control of a user menu, the information display of the item of identification information can also be an item on the user menu.

The single FIGURE of the drawing is a schematic illustration of a motor vehicle in whose front region an electronic device 1 which is illustrated as a box is installed. This device 1 requires official approval, the data for which are stored cryptographically encoded as an item of identification information in a read-only memory (ROM) which is integrated in the device 1.

The device 1 is connected via a line 2 to a display instrument 3 which is arranged in the dashboard of the motor vehicle. This display instrument 3 is illustrated in a separate enlarged view in the FIGURE.

The display face 4 of the display instrument 3 has a speed scale 5, a rotational speed scale 6, a fuel tank filling level indicator 7 and a display panel 8 which is embodied as a liquid crystal display.

A wide variety of information items can be displayed on the display panel 8 under the control of a user menu. One item on the user menu is, after decoding, the display of the item of identification information of the device 1 which is supplied by the device 1 via the line 2.

What is claimed is:

1. An identification system for an electrical or electronic device, which is provided with an item of identification information, wherein the device is of a size which is insufficient for the identification to be mounted with a readable size, and the electrical or electronic device contains an electronic memory in which the item of identification information is stored, wherein the memory is connected or can be connected to a display device which is arranged at a different location than the electrical or electronic device by means of which the item of identification information can be displayed.

2. The identification system according to claim 1, wherein the memory is a read-only memory (ROM).

3. The identification system according to claim 1, wherein the item of identification information is stored encoded in the memory, and the display device contains a decoding stage for decoding the item of identification information.

4. The identification system according to claim 3, wherein the item of identification information is stored cryptographically encoded in the memory.

5. The identification system according to claim 1, wherein the display device has an electro-optical display panel for displaying of the item of identification information.

6. The identification system according to claim 1, wherein the item of identification information is displayed by the display device on demand.

7. The identification system according to claim 1, wherein the object and/or the display device has an interface for coupling with a further display unit.

8. The identification system according to claim 7, wherein further display unit is a personal computer (PC).

9. The identification system according to claim 1, wherein the electrical or electronic device is an electrical or electronic device of a motor vehicle, and the display device is a display instrument which is arranged in the dashboard of the motor vehicle.

10. The identification system according to claim 9, wherein information is displayed by the display instrument under the control of a user menu, and the information display is an item on the user menu.

11. A method for identification for an electrical or electronic device, comprising the steps of:
provided the electrical or electronic device with an item of identification information, wherein the device is of a size which is insufficient for the identification to be mounted with a readable size, and the electrical or electronic device contains an electronic memory in which the item of identification information is stored,
connecting the memory to a display device which is arranged at a different location than the electrical or electronic device, and
reading the item of identification information and displaying the item of identification information on the display device.

12. The method according to claim 11, wherein the item of identification information is stored encoded in the memory, and the method further comprises the step of decoding the item of identification information.

13. The method according to claim 12, wherein the item of identification information is stored cryptographically encoded in the memory.

14. The method according to claim 11, wherein the display device has an electro-optical display panel for displaying of the item of identification information.

15. The method according to claim 11, wherein the item of identification information is displayed by the display device on demand.

16. The method according to claim 11, wherein the object and/or the display device has an interface for coupling with a further display unit.

17. The method according to claim 16, wherein the further display unit is a personal computer (PC).

18. The method according to claim 11, wherein the electrical or electronic device is an electrical or electronic device of a motor vehicle, and the display device is a display instrument which is arranged in the dashboard of the motor vehicle.

19. The method according to claim 18, wherein information is displayed by the display instrument under the control of a user menu, and the information display is an item on the user menu.
